(19) United States
(12) Patent Application Publication
(10) Pub. No.: US 2015/0154706 A1
(43) Pub. Date: Jun. 4, 2015

(54) SYSTEMS AND METHODS FOR FINANCIAL ASSET ANALYSIS

(71) Applicant: FINMASON, INC., Boston, MA (US)

(72) Inventor: Lawrence Kendrick Wakeman, Scituate, MA (US)

(21) Appl. No.: 14/558,299

(22) Filed: Dec. 2, 2014

Related U.S. Application Data
(60) Provisional application No. 61/910,542, filed on Dec. 2, 2013.

(51) Int. Cl. G06Q 40/06

(52) U.S. Cl. CPC G06Q 40/06

(57) ABSTRACT

Systems and methods are provided for analyzing financial assets under a plurality of economic scenarios. In general, the systems and methods can include an asset scenario analysis module for calculating performance metrics of a plurality of financial assets under each of the scenarios and storing the asset performance metrics in a database. Using the asset performance metrics, a portfolio scenario analysis module can calculate performance metrics under each of the scenarios for one or more investment portfolios that each includes a unique subset of the assets. The performance metrics of the one or more portfolios can be displayed on an interactive user interface, thereby allowing the user to dynamically compare the impact of changing the subset of assets that comprise the portfolios under each of the scenarios.

### CROSS-REFERENCE TO RELATED APPLICATIONS

The present application claims priority to U.S. Provisional Application No. 61/910,542, filed on Dec. 2, 2013 and entitled “Systems and Methods for Financial Asset Analysis,” which is hereby incorporated by reference in its entirety.

### FIELD

Exemplary embodiments of the present invention relate to systems and methods for financial asset analysis.

### BACKGROUND

Several approaches exist for making financial investment opportunities more accessible to the individual investor. Mobile phone apps and user-friendly websites are cropping up to allow individual users to pick and choose from a variety of financial assets. While these advances have helped to provide more investment options, however, they have failed to provide meaningful analytical measures of investments to help investors choose which options are really best for them.

Many currently available investment analytical platforms are designed exclusively for institutional investors. Such platforms include high-level analytical data that would be incomprehensible to a layperson and are often prohibitively expensive. To the extent they are available to the average individual investor, investment analytics largely focus on past fund performance and only provide esoteric risk measures for future performance.

Furthermore, many investment tools available to individual investors only provide information about a small subset of funds, for example the funds created by the entity providing the tool. Even in the world of “big data,” analysis of large numbers of funds—particularly any customized analysis—can require significant computational power and time. Accordingly, there remains a need for improved financial asset analysis.

### SUMMARY

The present invention generally provides systems and methods for analyzing financial assets under a plurality of economic scenarios. In one aspect, a method is provided for forecasting the performance of one or more portfolios of financial assets under one or more economic scenarios using a system consisting of one or more computer processors connected to one or more computer databases. The method can include accessing by the one or more computer processors data in the one or more databases. The data can include historical pricing data for a plurality of financial assets and historical valuation data for a plurality of factors with which the historical pricing data can be correlated. The method can also include performing by the one or more computer processors a regression analysis for the financial assets with respect to the factors to calculate regression parameters representing correlations between the financial assets and the factors and storing the regression parameters in the one or more databases. The one or more computer processors can receive definitions of a plurality of economic scenarios that include predicted values of the factors for the economic scenarios and can store the economic scenarios and the predicted values of the factors in the one or more databases. The one or more computer processors can access the one or more databases to retrieve regression parameters for each financial asset in the portfolio and one or more economic scenarios, including predicted values of the factors, for the one or more scenarios and can calculate performance metrics of the portfolio under the one or more economic scenarios using the regression parameters and the predicted values of the factors.

The method can further include receiving by the one or more computer processors one or more alternative selections of financial assets to form one or more alternative portfolios. The one or more computer processors can access the one or more databases to retrieve the regression parameters for each financial asset in the one or more alternative portfolios and one or more economic scenarios including the predicted values of the factors for the one or more scenarios. Using the regression parameters and the predicted values of the factors, the one or more computer processors can thus calculate performance metrics of the one or more alternative portfolios under the one or more economic scenarios. Then, the one or more computer processors can output the performance metrics of the portfolio and the one or more alternative portfolios under the one or more economic scenarios for display to a user. In some embodiments, the receiving of the one or more alternative selections of financial assets can further include providing by the one or more computer processors a user interface for a user to indicate allocations of a limited subset of financial assets in which the user is allowed to invest, and creating from indicated allocations the one or more alternative portfolios. In other embodiments, the receiving by the one or more computer processors of the one or more alternative selections of financial assets can further include providing by the one or more computer processors a user interface for a user to indicate allocations of the assets within the portfolio, and creating from indicated allocations the one or more alternative portfolios. In still further embodiments, the receiving by the one or more computer processors of the one or more alternative selections of financial assets can further include receiving by the one or more computer processors an indication of user preferences relating to portfolio performance under one or more of the scenarios, and selecting by the one or more computer processors of one or more assets for inclusion in the one or more alternative portfolios based on the user preferences.

In some embodiments, the method can further include calculating by the one or more computer processors of a ranking for a performance of each financial asset under the one or more economic scenarios and storing the rankings in the one or more databases. In still further embodiments, the plurality of financial assets can include a limited subset of funds in which a user is allowed to invest.

The method can further include modifying the portfolio by the one or more computer processors by adding one or more sponsored financial assets to create an alternative portfolio. The one or more computer processors can access the one or more databases to retrieve the regression parameters for each financial asset in the alternative portfolio and one or more economic scenarios including the predicted values of the factors for the one or more scenarios. Using the regression parameters and the predicted values of the factors, the one or more computer processors can thus calculate performance metrics of the alternative portfolio under the one or more economic scenarios. Then, the one or more computer processors can output the performance metrics of the portfolio and the alternative portfolio under the one or more economic scenarios for display to a user. In some embodiments, the method can further include providing by the one or more computer processors a user actuable link to information regarding the one or more sponsored financial assets. The one or more computer processors can then calculate an advertising fee for the one or more sponsored financial assets. In some embodiments, the method can further include calculating by the one or more computer processors which one or more from a plurality of sponsored financial assets will improve the performance of the portfolio under the one or more economic scenarios and adding the one or more sponsored financial assets to the portfolio to create the alternative portfolio.

In some embodiments, the method can further include clustering by the one or more computer processors the plurality of financial assets into clusters based on the historical pricing data for the plurality of financial assets. The one or more computer processors can perform a second regression analysis for the financial assets in each cluster with respect to the factors to identify subsets of the factors for each cluster that are correlated with the financial assets in the cluster. The aforementioned regression analysis for the financial assets can thus comprise a regression analysis for the financial assets in each cluster with respect to the subset of factors that are correlated with the cluster. In such embodiments, the method can further include determining by the one or more computer processors a goodness of fit of the regression parameters for each of the plurality of financial assets, and where the fit is determined to be below a threshold value, replacing the regression parameters for the financial asset with regression parameters for the cluster. The method can also include comparing by the one or more computer processors the performance metrics for each of the plurality of financial assets with the performance metrics for other financial assets in the same cluster and, where the performance metrics for a financial asset differ from the performance metrics for other financial assets in the same cluster by a predetermined amount, replacing the performance metrics for the financial asset with average values for performance metrics of the cluster.

In some embodiments, calculating performance metrics of the portfolio under the one or more economic scenarios using the regression parameters and the predicted values of the factors can include calculating performance metrics of each of the plurality of financial assets. The pre-calculated asset performance metrics can be stored in the one or more databases, and can be used to calculate performance metrics of the portfolio.

The present invention further provides devices, systems, and methods as claimed.

### BRIEF DESCRIPTION OF THE DRAWINGS

FIG. 1 is a schematic diagram of one exemplary embodiment of a computer system;

FIG. 2 is a schematic diagram of an exemplary embodiment of a scenario analysis system;

FIG. 3 is a flowchart that schematically depicts an exemplary method of an asset scenario analysis module for use with the system of FIG. 2;

FIG. 3A is an exemplary input to the asset scenario analysis module of FIG. 3;

FIG. 3B is another exemplary input to the asset scenario analysis module of FIG. 3;

FIG. 3C is another exemplary input to the asset scenario analysis module of FIG. 3;

FIG. 3D is an exemplary output of the asset scenario analysis module of FIG. 3;

FIG. 3E is another exemplary output of the asset scenario analysis module of FIG. 3;

FIG. 4 is a flowchart that schematically depicts an exemplary method of a portfolio scenario analysis module for use with the system of FIG. 2;

FIG. 5 is a flowchart that schematically depicts an exemplary method of a clustering module for use with the system of FIG. 2;

FIG. 6 is a flowchart that schematically depicts an exemplary method of a review module for use with the system of FIG. 2;

FIG. 7 is a flowchart that schematically depicts an exemplary method of a ranking module for use with the system of FIG. 2;

FIG. 8 is a flowchart that schematically depicts an exemplary method of an optimization module for use with the system of FIG. 2;

FIG. 9 is an exemplary view of the user interface for use with the systems and methods of the invention;

FIG. 10 is another view of the exemplary user interface of FIG. 9; and

FIG. 11 is another view of the exemplary user interface of FIG. 9;

### DETAILED DESCRIPTION OF THE INVENTION

Systems and methods are provided for analyzing financial assets under a plurality of economic scenarios using one or more computer servers and storage devices. In general, the systems and methods can include scenario analysis modules for determining performance metrics of a financial asset or a portfolio of financial assets under one or more of the scenarios. The performance metrics of a plurality of assets can be calculated by an asset scenario analysis module and stored in one or more databases. Based on the pre-calculated asset performance metrics, a portfolio scenario analysis module can calculate a single performance metric under each of the scenarios for a portfolio that includes a subset of the assets. The portfolio scenario analysis module can repeat the performance metric calculation for one or more alternative portfolios, each of which can include a different subset of assets from the first portfolio and from each other. The resulting performance metrics of the portfolio and the alternative portfolios can be displayed on a user interface. In this way, multiple portfolios can be compared to help a user select a subset of assets that will optimize performance of a portfolio under certain scenarios, while accounting for the negative impact to other scenarios.

Certain exemplary embodiments will now be described to provide an overall understanding of the principles of the structure, function, manufacture, and use of the methods, systems, and devices disclosed herein. One or more examples of these embodiments are illustrated in the accompanying drawings. Those skilled in the art will understand that the methods, systems, and devices specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Computer System

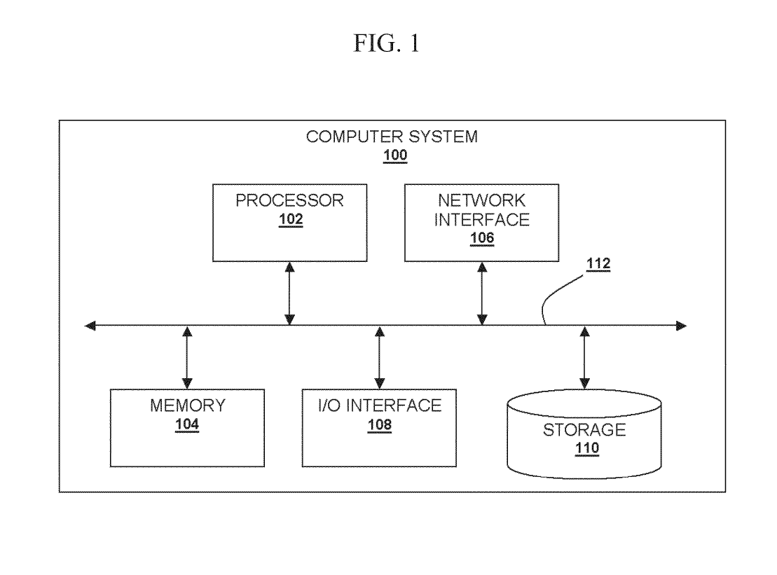

The systems and methods disclosed herein can be implemented using one or more computer systems, such as the exemplary embodiment of a computer system 100 shown in FIG. 1. As shown, the computer system 100 can include one or more processors 102 which can control the operation of the computer system 100. The processor(s) 102 can include any type of microprocessor or central processing unit (CPU), including programmable general-purpose or special-purpose microprocessors and/or any one of a variety of proprietary or commercially available single or multi-processor systems. The computer system 100 can also include one or more memories 104, which can provide temporary storage for code to be executed by the processor(s) 102 or for data acquired from one or more users, storage devices, and/or databases. The memory 104 can include read-only memory (ROM), flash memory, one or more varieties of random access memory (RAM) (e.g., static RAM (SRAM), dynamic RAM (DRAM), or synchronous DRAM (SDRAM)), and/or a combination of memory technologies.

The various elements of the computer system 100 can be coupled to a bus system. The bus system can be any one or more separate physical busses, communication lines/interfaces, and/or multi-drop or point-to-point connections, connected by appropriate bridges, adapters, and/or controllers. The computer system 100 can also include one or more network interface(s) 106, one or more input/output (TO) interface(s) 108, and one or more storage device(s) 110.

The network interface(s) 106 can enable the computer system 100 to communicate with remote devices (e.g., other computer systems) over a network, and can be, for example, remote desktop connection interfaces, Ethernet adapters, and/or other local area network (LAN) adapters. The IO interface(s) 108 can include one or more interface components to connect the computer system 100 with other electronic equipment. For example, the IO interface(s) 108 can include high speed data ports, such as USB ports, 1394 ports, etc. Additionally, the computer system 100 can be accessible to a human user, and thus the IO interface(s) 108 can include displays, speakers, keyboards, pointing devices, and/or various other video, audio, or alphanumeric interfaces. The storage device(s) 110 can include any conventional medium for storing data in a non-volatile and/or non-transient manner. The storage device(s) 110 can thus hold data and/or instructions in a persistent state (i.e., the value is retained despite interruption of power to the computer system 100). The storage device(s) 110 can include one or more hard disk drives, flash drives, USB drives, optical drives, various media cards, and/or any combination thereof and can be directly connected to the computer system 100 or remotely connected thereto, such as over a network. The elements illustrated in FIG. 1 can be some or all of the elements of a single physical machine. In addition, not all of the illustrated elements need to be located on or in the same physical or logical machine. Rather, the illustrated elements can be distributed in nature, e.g., using a server farm or cloud-based technology. Exemplary computer systems include conventional desktop computers, workstations, minicomputers, laptop computers, tablet computers, PDAs, mobile phones, and the like.

Although an exemplary computer system is depicted and described herein, it will be appreciated that this is for sake of generality and convenience. In other embodiments, the computer system may differ in architecture and operation from that shown and described here.

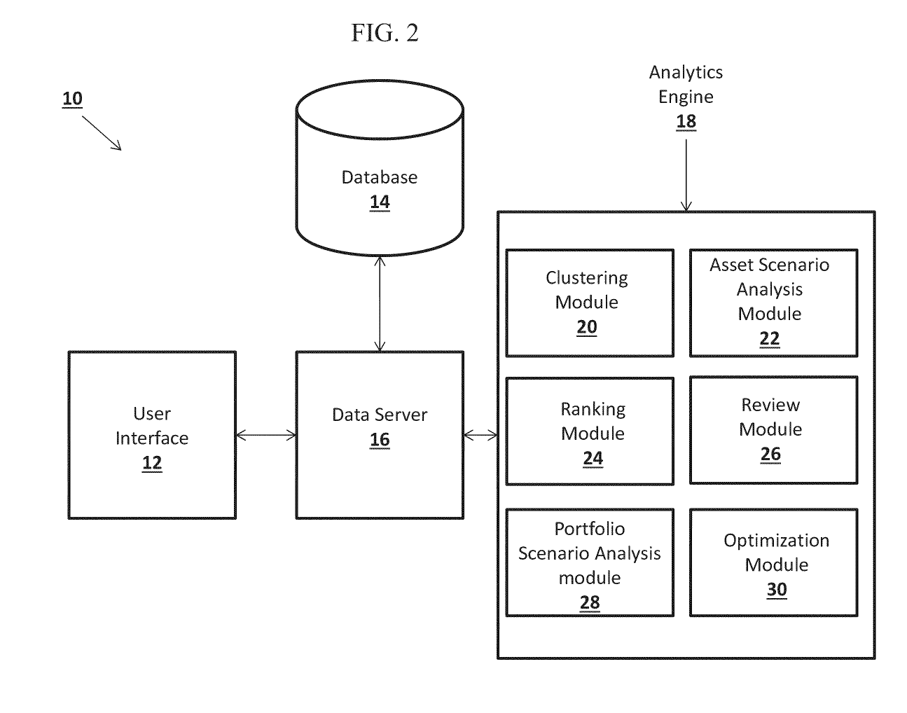

By way of non-limiting example, the systems and methods disclosed herein can be implemented by the exemplary system 10 illustrated in FIG. 2. In this embodiment, the system 10 includes a user interface 12, a database 14, a data server 16, and an analytics engine 18. The user interface 12 can include various graphical user interfaces, such as websites, mobile applications, etc., for displaying output (e.g., graphs, text, videos, etc.) from the analytics engine 18 and for providing options for user input (e.g., buttons, input boxes, etc.). The database 14 can store various types of data, e.g., information related to one or more economic scenarios, information related to one or more financial assets, etc. The data server 16 can mediate between the user interface 12, the database 14, and the analytics engine 18, for example by receiving user input from the user interface 12 and data from the database 14 and outputting the user input and the data to the analytics engine 18. Based at least in part on the user input from the user interface 12 and the data from the database 14, the analytics engine 18 can return performance metrics of one or more assets and/or portfolios under each of the scenarios, which can be returned to the user interface 12 via the data server 16. In some embodiments, the data server 16 can restrict access to any of the user interface 12, the database 14, and/or the analytics engine 18 based on user permissions and/or login information.

The system 10 can thus be implemented on a single computer system, or can be distributed across a plurality of computer systems, e.g., across a “cloud.” Although the system is illustrated as having only a single user interface 12, database 14, data server 16, and analytics engine 18 for the sake of simplicity, the system can include a plurality of each of the aforementioned components. It will be appreciated that any of the computer features disclosed herein can be subdivided or can be combined with other features.

Analytics Engine

The various functions performed by the analytics engine 18 can be logically described as being performed by one or more modules. It will be appreciated that such modules can be implemented in hardware, software, or a combination thereof. It will further be appreciated that, when implemented in software, modules can be part of a single program or one or more separate programs, and can be implemented in a variety of contexts (e.g., as part of an operating system, a device driver, a standalone application, and/or combinations thereof). In addition, software embodying one or more modules is not a signal and can be stored as an executable program on one or more non-transitory computer-readable storage mediums. Functions disclosed herein as being performed by a particular module can also be performed by any other module or combination of modules.

In general, the analytics engine 18 can operate as follows: an asset scenario analysis module 22 can “pre-calculate” performance metrics for a plurality of financial assets under one or more economic scenarios. For example, for a given asset A₁, the asset scenario analysis module 22 can calculate an estimated price of the asset V_{A1} in a variety of economic conditions, e.g., a bull market, a bear market, etc. In one exemplary embodiment, the asset's performance can be calculated using regression models that relate asset performance to a plurality of economic factors. Each factor can have an estimated value for each scenario, which can be input to the regression models to produce an estimated value for asset performance in that that scenario. In this way, performance metrics can be calculated for a plurality of assets in a plurality of scenarios and stored in the database 14.

Given the pre-calculated performance metrics for a plurality of assets, a portfolio scenario analysis module 28 can quickly and easily calculate performance metrics for a portfolio including a subset of the assets under one or more of the scenarios. To help a user compare different investment options, the portfolio scenario analysis module 28 can further calculate performance metrics under each of the scenarios for one or more alternative portfolios, each of the alternative portfolios including a different subset of the assets from the first portfolio and from one another. The portfolio scenario analysis module 28 can output the performance metrics of the portfolio together with the performance metrics of the one or more alternative portfolios to the user interface 12, thereby allowing a user to dynamically compare the impact of changing the subset of assets that comprise the portfolios under each of the scenarios. Because the bulk of the calculations have already been performed by the asset scenario analysis module 22, the calculation of portfolio performance metrics requires minimal computational power and can be performed nearly instantaneously and on a variety of mobile devices, thereby allowing users to “play” with different variables at any time.

In some embodiments, to help simplify and ensure the accuracy of the performance metric calculations, a clustering module 20 can organize the plurality of financial assets into clusters having similar properties. Values calculated for an asset that fall significantly outside the range of values for other assets in the cluster can be flagged and sent to a review module 26 for review and any necessary editing.

In still further embodiments, an optimization module 30 can help a user to create an alternative portfolio that maximizes performance under one or more scenarios, while recognizing the negative impact to performance under other scenarios. For example, the optimization module 30 can suggest assets for inclusion in an alternative portfolio based on the assets' performance in one or more scenarios that a user would like to improve. In some embodiments, the optimization module 30 selects assets based on rankings determined by a ranking module 24, which calculates a ranking for each of the assets under each of the scenarios based on the asset performance metrics.

The analytics engine 18 can include fewer or more modules than what is shown and described herein and can be implemented using one or more digital data processing systems of the type described above.

The Scenarios

The economic scenarios can describe real and hypothetical market conditions and events, including conditions and events that are rare or extreme. By way of non-limiting example, the scenarios can include traditional market conditions, e.g., bull market, moderate market, bear market, etc.; historical market events, e.g., the 2008 crisis, the tech burst, the 1987 crash, etc.; and/or hypothetical market events, e.g., federal tightening, a U.S. debt crisis, a middle east war, etc.

Each of the economic scenarios can be associated with values or changes in values for a plurality of economic factors, or a subset of the plurality of factors. For example, the bull market scenario can be associated with a Dow Jones index value of 1800 and a Rasumssen Consumer Index value of 130. In general, the factors can be any measure that can influence the performance of a financial asset, e.g., market performance indicia such as the Dow Jones index, measures of public sentiment such as consumer confidence indices, economic events, political events such as presidential elections, etc. Where the factor is not already associated with a numerical value, a numerical value can be assigned to that factor for a given time period. For example, for presidential elections, a “1” can be used to denote a year in which there was a presidential election, and a “0” can be used to denote a year in which there was not a presidential election. In some embodiments, a factor can also constitute a scenario, e.g., war between the U.S. and the Middle East. In such situations, the scenario is simply associated with a single value for the corresponding factor. The scenarios and their associated factor values can be defined manually by a human and/or automatically by one or more computer processors, and can be stored in the database 14.

Asset Scenario Analysis Module

One exemplary embodiment of the asset scenario analysis module 22 can be configured to calculate performance metrics for the plurality of assets under one or more of the scenarios and store the performance metrics in the database 14. In particular, the asset scenario analysis module 22 can estimate asset performance based on regression models that relate asset performance to the economic factors. In this way, the performance metrics can be “pre-calculated” for a large number of assets and readily available for display to a user and/or further analysis, as explained below. In some embodiments, the number of assets can be very large, thus requiring significant computational power for the calculation and storage of the asset performance metrics. For this reason, the use of cloud-based technology can be particularly useful for use with the asset scenario analysis module 22.

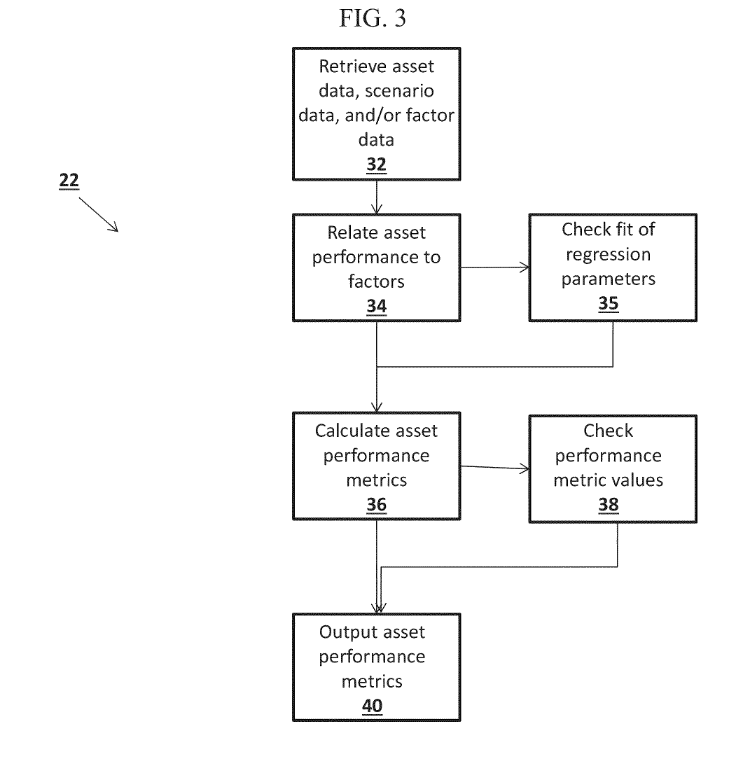

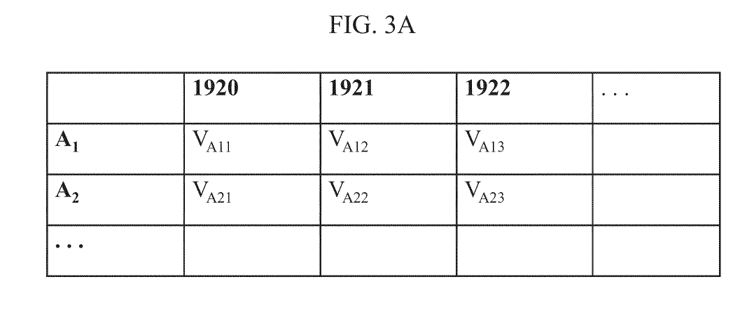

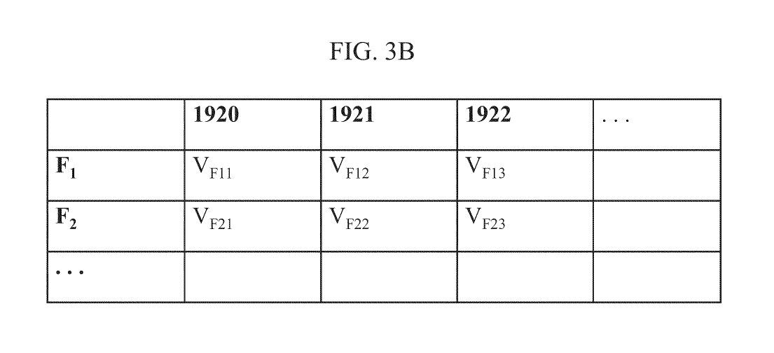

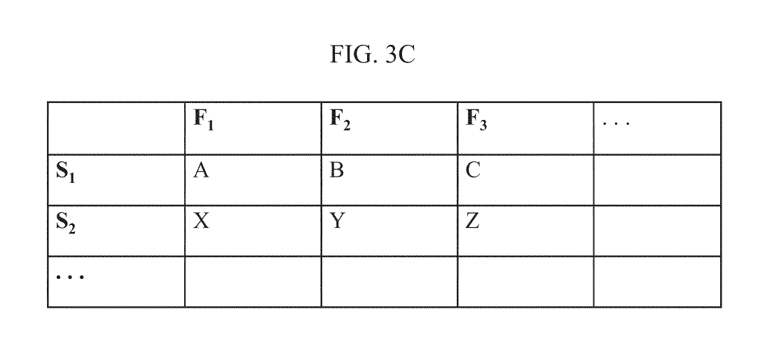

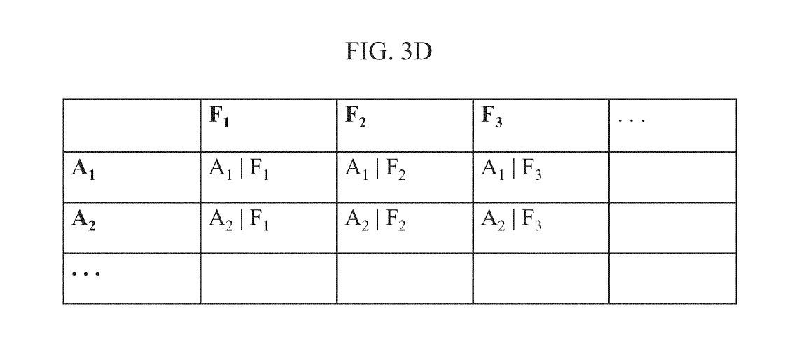

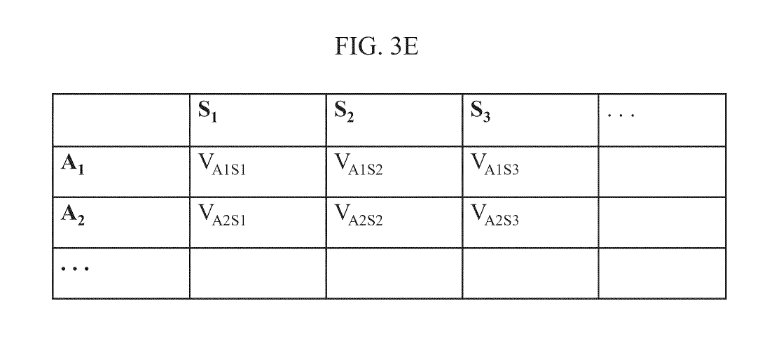

An exemplary method carried out by the asset scenario analysis module 22 is illustrated in FIG. 3. First, in step 32, the asset scenario analysis module 22 can retrieve asset data for a plurality of assets. Exemplary asset data retrieved by the asset scenario analysis module 22 is illustrated in FIG. 3A and includes prices V of a plurality of assets A₁, A₂, etc., over time. Although the asset prices are broken down by year in FIG. 3A, it will be appreciated that pricing data can be stored and/or retrieved for any time increment. In some embodiments, in addition to the historical pricing data illustrated in FIG. 3A, the asset data can include regression parameters that relate the asset to the economic factors, as described below. The asset data can be retrieved in a variety of ways, e.g., manually by a user from the user interface 12, automatically from the database 14 and/or from a third party such as a financial institution, etc. Notably, the assets can include any object of monetary value, including funds, instruments, contractual obligations, etc.

Also at step 32, the asset scenario analysis module 22 can retrieve factor data. In an exemplary embodiment, illustrated in FIG. 3B, the factor data includes values V for each of a plurality of factors F over time. As with the asset data, the factor data can be retrieved and/or stored for any time increment, although in the illustrated embodiment each factor has a single value for each year. Finally, the asset scenario analysis module 22 can retrieve scenario data. As illustrated in FIG. 3C, exemplary scenario data for a plurality of scenarios S₁, S₂, etc., can include values for a plurality of the factors F₁, F₂, etc. that are associated with each scenario.

The asset scenario analysis module 22 can then relate the asset data to the factor data to predict asset performance for any given set of factor values (step 34). In an exemplary embodiment, the calculation is performed using regression analysis. For example, the asset scenario analysis module 22 can correlate rates of return for each of the assets, calculated based on the historical pricing data for the assets (e.g., the data shown in FIG. 3A), with the historical valuation data for the factors (e.g., the data shown in FIG. 3B). The regression analysis can be performed using several models, although in some embodiments only the result from the best model is output. The best model can include blended models, and can be determined using statistical and non-statistical measures of accuracy. An exemplary result of the regression analysis is illustrated in FIG. 3D and includes regression parameters relating each factor to each asset. For example, for the asset A₁, the regression analysis can produce regression parameters A₁|F₁, A₁|F₂, and A₁|F₃, relating the performance of the asset A₁ to the value of the factors F₁, F₂, and F₃, respectively. Collectively, the regression parameters for each factor can be used as a regression model relating all of the factors to the asset's performance.

At step 36, the asset scenario analysis module 22 can use the regression models to calculate performance metrics for each asset under one or more of the scenarios. Specifically, for each scenario, the scenario analysis module 22 can input the predicted values for the factors, or changes in values of the factors, that are associated with that scenario into the regression models to produce an estimated performance metric for each asset. For example, to determine performance metrics for the asset A₁ for the scenario S₁, the asset scenario analysis module 22 can input the factor values (A, B, C, . . . ) for the scenario S₁ into the regression model for the asset A₁.

Exemplary output from the asset performance metric calculation is illustrated in FIG. 3E, and includes at least one performance metric V_{AS} for each asset A for one or more of the scenarios S. The performance metrics can be any measure of the asset's performance, for example rate of return of the asset, a price of the asset, etc. Furthermore, the performance metrics output from the regression models can be used to calculate other performance metrics. By way of non-limiting example, where the performance metric is a rate of return of the asset, the rate of return can be used to calculate a price of the asset at a given point in time. Additionally or alternatively, the asset scenario analysis module 22 can calculate risk metrics of the asset, e.g., a standard deviation.

In some embodiments, the asset scenario analysis module 22 can include a screening step 35 for assessing the accuracy of the regression parameters and/or a screening step 38 for assessing the accuracy of the performance metrics. In the screening steps 35, 38, described in more detail below, calculated values can be screened for accuracy and, if deemed to be inaccurate, can be replaced with values that are more likely to be accurate.

At step 40, the calculated performance metrics, risk metrics, and/or regression parameters can be output to the database 14 and/or displayed on the user interface 12. In some embodiments, the asset scenario analysis module 22 can be repeatedly run at regular intervals for each asset to ensure that the database 14 contains updated information based on current asset price histories.

Where the asset is a composite asset, e.g., a mutual fund, the asset scenario analysis module 22 can calculate performance metrics under each of the scenarios for the composite asset using similar methods to those described above for calculating performance metrics of the individual assets. The resulting performance metrics of the composite asset and for each asset that comprises the composite asset can be compared for accuracy. Where the performance metrics for the composite asset differ substantially from the performance metrics for its component assets, the asset scenario analysis module 22 can flag the performance metrics for the composite asset for review by the review module 26 (step 40).

Portfolio Scenario Analysis Module

The portfolio scenario analysis module 28 can calculate performance metrics of a portfolio of financial assets under the economic scenarios based on the pre-calculated asset performance metrics. Because the bulk of the calculations have been performed by the asset scenario analysis module 22, the portfolio scenario analysis module 28 can provide an overall portfolio analysis quickly and efficiently given an identity and a weight of each asset in the portfolio. In some embodiments, only a single performance metric for each scenario is output to the user, thereby providing a simple, straight-forward means of understanding portfolio performance under each of the scenarios. By thus providing measures for performance under each scenario, the scenario analysis module 28 can provide users with a realistic picture of future portfolio performance. It can also help to shield fiduciaries such as asset managers, plan sponsors, and advisors from liability for providing misleading information about future fund performance.

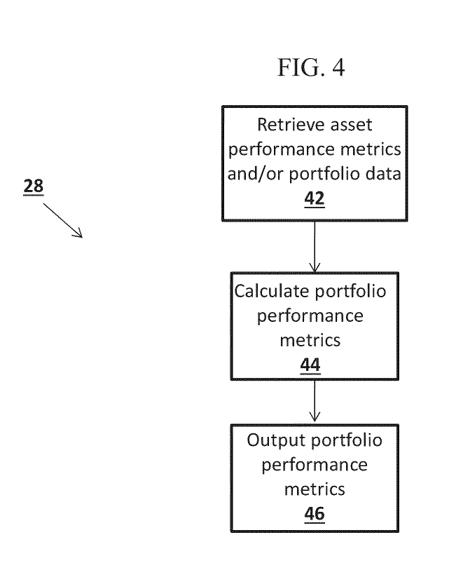

An exemplary method executed by the portfolio scenario analysis module 28 is illustrated in FIG. 4. First, the portfolio scenario analysis module 28 can retrieve asset performance metrics for a first subset of assets that comprise a first portfolio under one or more of the scenarios (step 42). The portfolio analysis module 28 can also retrieve portfolio data, which can include asset weights for each of the first subset of assets. In some embodiments, the portfolio data can be input manually by a user or uploaded from a third party source, such as a financial institution, at the request of the user. The portfolio data can also be automatically input to the portfolio scenario analysis module 28, for example from the database 14, from the third party source, or from the optimization module 30, which is explained below.

Based on the weight of each asset in the first portfolio and the pre-calculated performance metrics of each of the assets in the first portfolio, the portfolio scenario analysis module 28 can calculate performance metrics of the first portfolio under one or more of the scenarios (step 44). The calculation can be as simple as combining the performance metrics for each asset according to the weight of the asset. For example, where the asset A₁ makes up 30% of the first portfolio and the asset A₂ makes up 70% of the first portfolio, portfolio performance in an exemplary scenario S₁ can be 0.3 (V_{A1S1})+0.7 (V_{A2S1}), where V_{A1S1} and V_{A2S1} are the performance metrics for the assets A₁, A₂, respectively, in the scenario S₁.

The performance metrics of the first portfolio can be stored in the database 14 and/or output to the user interface 12 (step 46). As with the asset performance metrics, the portfolio performance metrics can be any measure of the portfolio's performance, e.g., a rate of return of the portfolio, a value of the portfolio at a given point in time, etc.

The portfolio scenario analysis module 28 can further provide a user with a means for comparing alternative portfolios, each having a different subset of assets, to help the user optimize performance of a portfolio in certain scenarios while recognizing the negative effects to other scenarios. For example, a second portfolio, including a second subset of assets that is different from the first subset of assets, can be input to the portfolio scenario analysis module 28 (step 42), which can calculate performance metrics for the second portfolio under one or more of the scenarios (step 44). The resulting performance metrics of the second portfolio can then be output to the database 14 and/or the user interface 12 (step 46), optionally alongside the performance metrics of the first portfolio. The portfolio scenario analysis module 28 can repeat the calculation step 80 for multiple portfolios, each having a different subset of assets from one another, to allow a user to compare alternative portfolios.

Clustering Module

The clustering module 20 can group similar assets into “clusters” to help simplify and the asset and/or portfolio performance calculations. In particular, the clustering module 20 can identify factors that are relevant to assets within each cluster, and the asset scenario analysis module 22 can limit the regression analysis (step 34) for each asset to those factors that are relevant to a cluster it has been assigned to. This can simplify asset performance calculations by reducing the number of factor variables involved in the calculation. Furthermore, as described in greater detail below, the clusters can be used by other modules to help ensure the accuracy of asset performance calculations.

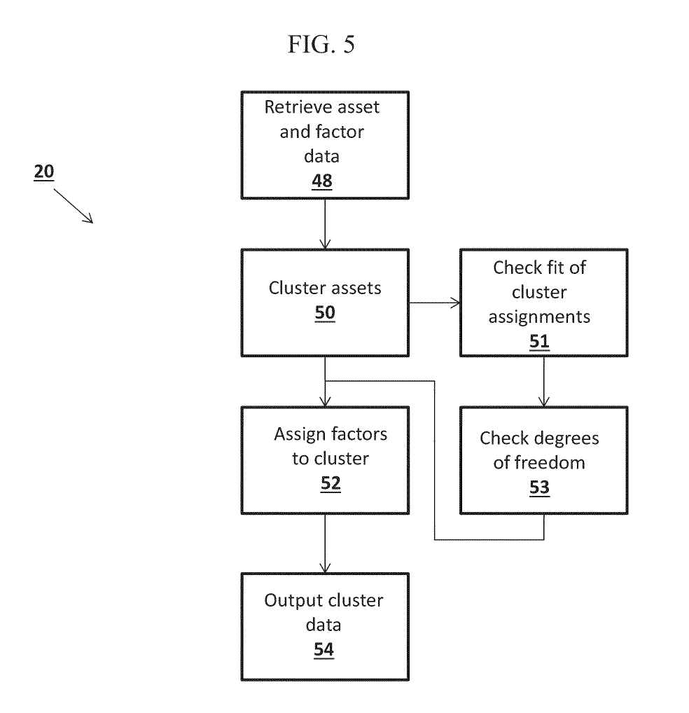

An exemplary method performed by the clustering module 20 is illustrated in FIG. 5. The method begins with retrieving asset data for a plurality of assets and factor data for a plurality of factors (step 48). The asset data can include identification information about each of the assets, historical pricing data for the assets (e.g., that data illustrated in FIG. 3A), and/or asset regression parameters that relate asset performance to factor values (e.g., the data illustrated in FIG. 3D). The factor data can similarly include identification information about each of the factors and/or historical valuation data for the factors (e.g., the data illustrated in FIG. 3B).

Based at least in part on the asset data, the clustering module 20 can group the assets into clusters (step 50). Initially, the clustering step can include unsupervised clustering techniques in which the algorithm determines the number and type of asset clusters. Later steps in the clustering process may include supervised clustering techniques and/or manual review of the computer-generated clusters by an administrator. In an exemplary embodiment, the assets are clustered based on historical pricing data; however, it will be appreciated that the clusters can be aggregated based on other properties of the assets, e.g., based on identities of the assets.

At step 52, the clustering module 20 can assign a subset of the plurality of factors to each cluster. The assigned subset of factors can include those factors that are likely to be relevant to the assets in each cluster. For example, economic events in the United States can be a factor that is assigned to a cluster that only includes funds based in the United States. In an exemplary embodiment, the assignment can be performed by a combination of computational and manual review. For example, for each cluster, the clustering module 20 can run stepwise regressions to correlate historical pricing data for each asset within the cluster with historical valuation data for all the factors. Only those factors whose values are determined to sufficiently correlate with the historical pricing data for the assets in the cluster (e.g., where the average correlation is above a threshold value) are selected by the clustering module 20 for inclusion in the subset of factors that are relevant to the cluster. In some embodiments, the factors selected for each cluster by computational methods can be reviewed manually to eliminate spurious correlations between asset performance and logically unrelated factors.

In some embodiments, the clustering module 20 can calculate regression parameters for each cluster that relate performance metrics of all the assets in the cluster with values for each of the factors. The correlation can be performed via regression analysis, similar to that described above as being performed by the asset scenario analysis module 22 for each asset.

Once the clusters have been established, new assets input to the clustering module 20 can simply be assigned to existing clusters in step 50. In an exemplary embodiment, the new asset can be assigned to an existing cluster by comparing historical pricing data of the new asset with historical pricing data of the other assets within each cluster to determine which cluster includes assets that are most similar to the new asset. However, it will be appreciated that the clustering module 20 can compare other characteristics of the new asset with those characteristics of assets in existing clusters to assess similarity. The clustering module 20 can then assign the new asset to the cluster to which it is most similar.

At step 54, the clustering module 20 can output the clusters, their associated factors, and/or the regression parameters for each cluster to, e.g., the user interface 12, the database 14, and/or to the asset scenario analysis module 22.

In some embodiments, the clustering module 20 can include a screening step 51 for assessing the accuracy of the cluster assignments. For example, in step 51, the clustering module 20 calculates metrics for the goodness of fit of the assets within their assigned clusters, e.g., r². If the goodness of fit for an asset exceeds a threshold value, the asset remains in the cluster. Otherwise, the clustering module 20 can assign the asset to a different cluster based on other characteristics of the asset, e.g., an identity of the new asset. For example, a short-term bond fund can be assigned to a cluster consisting of other short-term bond funds. In other embodiments, where the goodness of fit does not exceed the threshold value, the clustering module 20 can cause the asset to be manually assigned to a cluster.

In still further embodiments, the clustering module 20 can include a second screening step 53 to determine whether there is sufficient, accurate information about each asset for assigning the asset to a cluster. For example, in step 53, the clustering module 20 can calculate the degrees of freedom for each asset. If the calculation indicates that there is insufficient information to provide for accurate clustering, e.g., the track record of the asset is too short, values calculated for that asset can be replaced with values for other assets in the cluster. For example, regression parameters associated with the asset can be replaced with regression parameters for the cluster.

As mentioned above, the clusters can be used to assess the accuracy of values calculated by the asset scenario analysis module 22, and/or to replace the calculated values with values that are more likely to be accurate. Thus, using the clusters, the asset scenario analysis module 22 can provide accurate performance metrics quickly and without the need for manual review. For example, at step 35 (FIG. 3), the asset scenario analysis module 22 can compare assess the fit, e.g., r², of the regression models for each asset. If the asset scenario analysis module 22 determines that the fit is below a threshold value, the asset scenario analysis module 22 can simply substitute the regression parameters for the asset with the regression parameters for the cluster, or for regression parameters of any other asset in the cluster. Similarly, at step 38, the asset scenario analysis module 22 can compare the performance metrics for each asset with performance metrics for assets within the same cluster. If the asset scenario analysis module 22 determines that the difference is outside a predetermined tolerance range, the asset scenario analysis module 22 can replace the performance metric value with performance metric values for one or more assets in the same cluster as the asset. For example, the performance metric value can be replaced with an average performance metric value of all assets in the same cluster as the asset. In other embodiments, the performance metric value can be replaced with a performance metric value that is somewhere within a predetermined tolerance from the cluster average.

Review Module

The review module 26 can review and resolve issues that have been flagged for review by any of the other modules, either automatically or manually. In particular, assets identified by any of the aforementioned screening steps 25, 28, 51, and/or 53 can be flagged for review and received by the review module 26. Thus, by way of non-limiting example, the flagged issues can include regression parameters and/or performance metrics calculated by the asset scenario analysis module 22 that fall outside of expected ranges. The ranges can be user-specified and/or defined automatically, and can be based on statistical measures of accuracy, e.g., goodness of fit. Issues can also be flagged (e.g., manually) based on external sources, such as news sources or market data, that may cause unpredictable fluctuations in asset value.

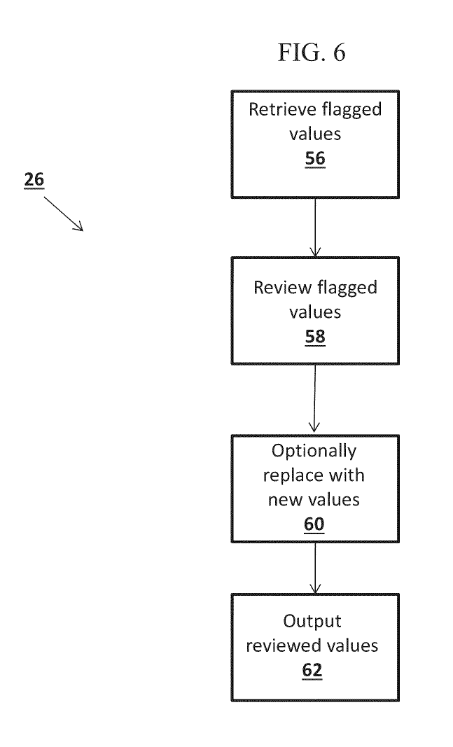

As illustrated in the exemplary method of FIG. 6, the review module 26 can first retrieve the flagged values (step 56). The values are then reviewed (step 58) according to an automated or semi-automated method. For example, in some embodiments, the review module 26 can perform statistical analysis to provide statistical measures of accuracy, which can then be reviewed manually by a human. Where manual review is required, the review module 26 can group flagged values together, e.g., based on the cluster data, to minimize the number of values that are manually reviewed. The review module 26 can thus provide a venue for human discretion and expertise. Because some embodiments of the method of the review module 26 are automated or semi-automated, however, the method need not require excessive human intervention.

Depending on the results of the review, the flagged values can be edited and/or replaced (step 60) and the new values can be stored in the database 14, output to the user interface 12, and/or input to the scenario analysis modules 22, 28 (step 62). Notably, a value is less likely to be replaced in step 60 with a new value if either the value itself or other values used to calculate the value have already passed through the review module 26.

Ranking Module

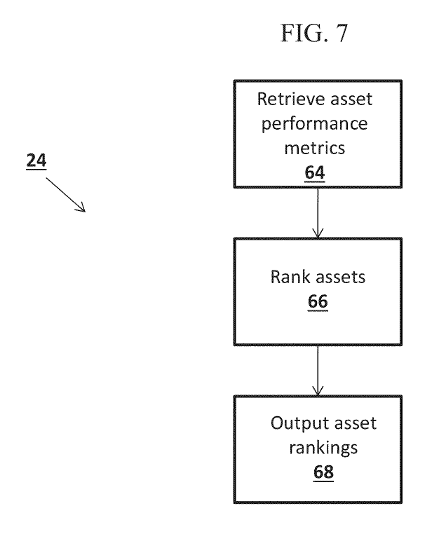

Using the asset performance metrics, the ranking module 24 can rank the assets relative to one another for performance under each of the scenarios. As illustrated in FIG. 7, a first step performed by the ranking module 24 can include retrieving asset performance metrics for each of a plurality of assets (step 64). The ranking module 24 can then determine a rank for each asset under each scenario based on its performance metrics in that scenario compared to the performance metrics of other assets in that scenario (step 66). In some embodiments, the ranking can be based on a comparison of the asset's performance compared to all other assets, or simply to other assets in the asset's cluster. The resulting rankings can be output to the user interface 12, the database 14, and/or to the optimization module 30, described below (step 68).

In some embodiments, based on the rankings for each scenario, the ranking step 62 can include assigning an overall ranking to each asset. The overall raking can take into account a user-specified and/or predetermined weight of the scenarios. For example, performance metrics of the assets in the first scenario S₁ can be weighted more heavily than performance metrics of the assets in the second scenario S₂, such that an asset with higher performance in the second scenario S₂ could still have a lower overall ranking than an asset with very high performance in the first scenario S₁. Like the scenario rankings, the overall ranking can also be output to the user interface 12, the database 14, and/or to the optimization module 30 at step 64. In some embodiments, the rankings can be displayed to a user on the user interface 12 alongside the performance metrics of each asset output by the asset and portfolio scenario analysis modules, which can enable the user to understand performance metrics in both relative and absolute terms and to efficiently select assets that will optimize the user's portfolio under certain scenarios. Like the asset performance metrics, the rankings can be pre-calculated by the ranking module 24, such that they can be provided “on demand.”

Optimization Module

The optimization module 30 can select an asset or a subset of assets from the plurality of assets that would optimize performance of a portfolio under one or more of the scenarios. The optimization can include balancing the positive impact of asset modification on some scenarios with the negative impact on other scenarios. In some embodiments, the optimization analysis can be performed at the request of a user. In other embodiments, the optimization analysis can be performed automatically to provide suggested assets to users.

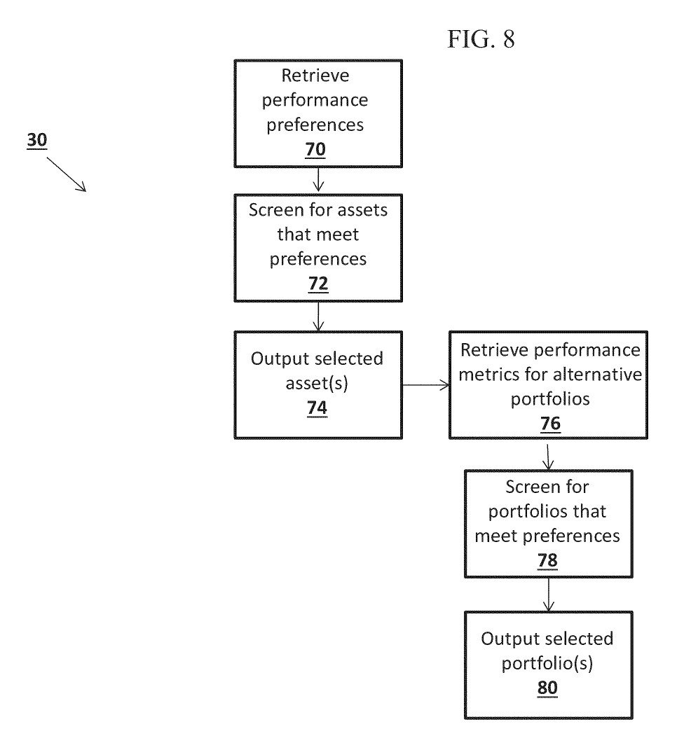

An exemplary method to be performed by the optimization module 30 is illustrated in FIG. 8. A first step of the exemplary method performed by the optimization module 30 is retrieving performance preferences (step 70). The performance preferences can include one or more scenarios to be improved and/or specific parameters for the improvement. In an exemplary embodiment, the parameters can include at least a desired portfolio performance range under one or more of the scenarios. The performance preferences can be based on one or more indicators of a user's preferences, e.g., a user's explicit request for improved performance in one or more of the scenarios, a user's past preference history, a user's current portfolio performance, current public sentiment, the economic macro-environment, etc. In some embodiments, however, at least the desired performance range can be automatically set by the optimization module 30.

Given the performance preferences, the optimization module 30 can search the database 14 for assets that meet the performance preferences (step 72). For example, where the performance preferences indicate that a user would like to improve performance under the scenario S₁, the optimization module 30 can screen for all the assets having a ranking above a threshold value for the scenario S₁, e.g., for assets ranked within the top 50 assets for the scenario S₁. One or more selected assets that fall within the desired performance range can then be output to a database 14, the user interface 12, and/or the portfolio scenario analysis module 28 as part of a portfolio (step 74).

Where the one or more selected assets are output to user interface 12, the user can select one or more of the assets for inclusion in an alternative portfolio, which can be input to the portfolio scenario analysis module 28. In other embodiments, the selected assets can each be automatically included in an alternative portfolio, each of which can then be input into the portfolio scenario analysis module 28. The portfolio scenario analysis module 28 can calculate performance metrics for each of the alternative portfolios under each of the scenarios. In some embodiments, the performance metrics for each of the alternative portfolios can be input back into to the optimization module 30 (step 76).

Given the performance metrics for the one or more alternative portfolios, the optimization module 30 can screen for portfolios that meet the performance preferences (step 78). In some embodiments, the optimization module 28 can simply screen the alternative portfolios for those having performance metrics for a given scenario, e.g., the scenario S₁, that are above a threshold value. In other embodiments, the optimization module 30 can perform an optimization to optimally balance the positive impact of the additional asset(s) on some scenarios with the negative impact on other scenarios, based on the performance preferences.

The performance metrics of one or more optimal alternative portfolios can be output together with the performance metrics of the user's current portfolio, e.g., to the user interface 12 (step 80). In this way, the optimization module 30 can provide the user with a “what-if” analysis based on the addition of the one or more selected assets, which can allow users to screen assets to optimize overall portfolio performance in certain scenarios while also understanding the negative impact to other scenarios.

User Interface

Output from any of the above described modules can be output to the user interface 12 to help a user understand their portfolio and assist the user in making changes to their portfolio to produce desired financial outcomes.

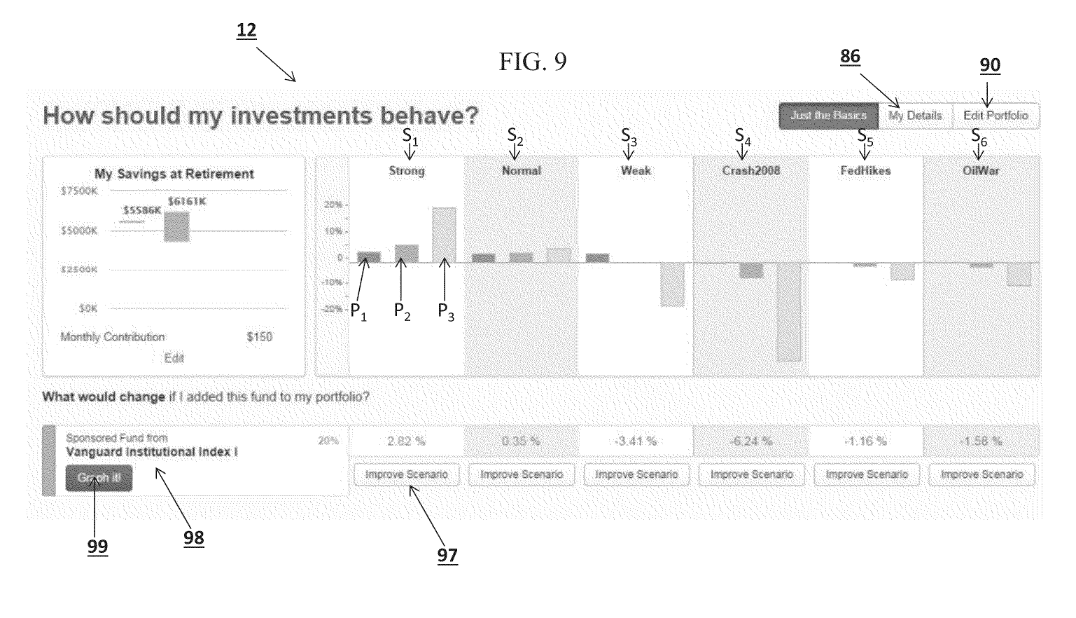

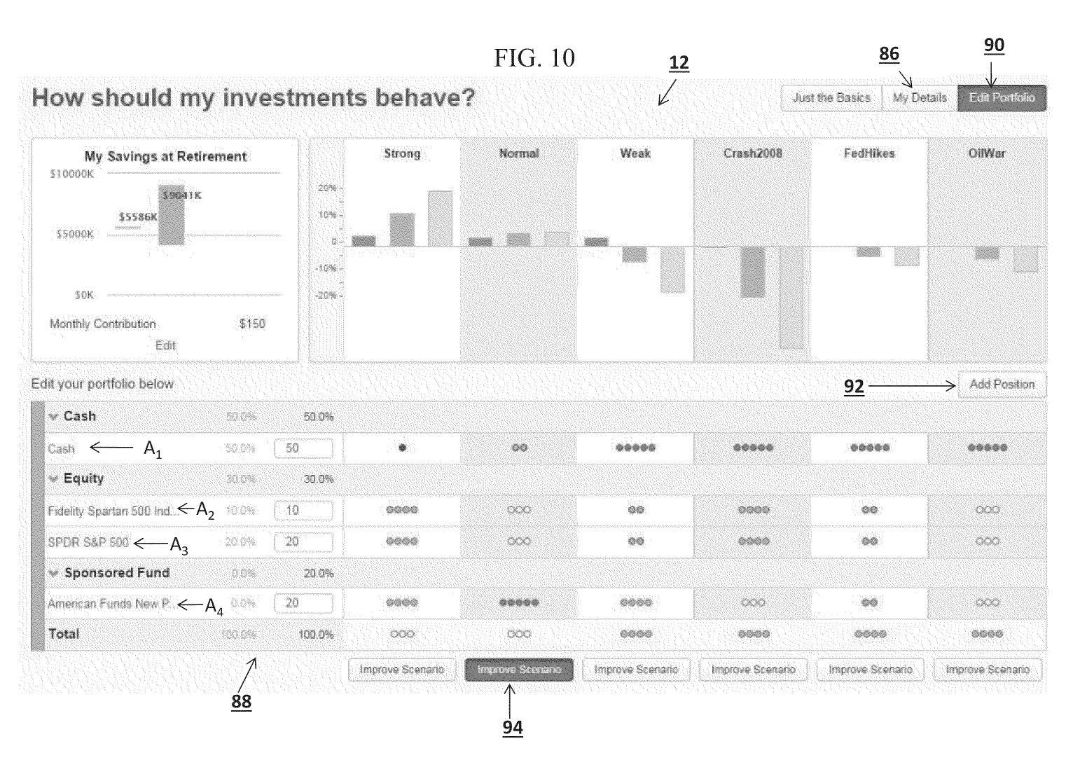

One exemplary embodiment of the user interface 12 is illustrated in FIGS. 9-11. By way of non-limiting example, the user interface 12 can graphically depict a single performance metric, e.g., a rate of return, for three different portfolios P₁, P₂, and P₃ under six scenarios S₁, S₂, S₃, S₄, S₅, and S₆. The portfolios P₁, P₂, and P₃ can be standardized, and/or can be displayed selectively based upon any one or more of a user's explicit request for improved performance in one or more scenarios, e.g., a user's past preference history, average user preferences, a user's current portfolio performance, current public sentiment, and the economic macro-environment. By way of non-limiting example, the portfolio P₁ can be the user's portfolio, the portfolio P₂ can be an alternative hypothetical portfolio, and the portfolio P₃ can be a benchmark portfolio, e.g., an index, a 60/40 portfolio, etc. In the illustrated embodiment, the performance metric is a rate of return. The rate of return is depicted as a bar extending in either an upward or downward direction to indicate either a positive or negative return, respectively. A distance that the bar extends in either direction reflects the magnitude of the rate of return in that direction. Viewing each of the portfolios P₁, P₂, and P₃ in a side-by-side comparison can enhance user understanding of the user's portfolio relative to other portfolios.

The user interface 12 can also help a user to understand a contribution of each asset in the user's portfolio to the overall performance of the portfolio. For example, clicking on button 86 (“my details”) can bring up a window which illustrates each of the individual assets A₁, A₂, A₃, and A₄ that make up the user's portfolio P₁, and a ranking of each asset in each of the scenarios relative to the other assets. In the illustrated embodiment, the rankings are represented by a number of either red or green dots, with red dots indicating a low ranking and green dots indicating a high ranking. The number and/or darkness of the dots reflect how high or how low the asset is ranked. For example, five dark green dots can indicate that an asset is ranked within the top 20% of all assets. These metrics are merely provided for purposes of illustration, however, and can be any graphical representation of any measure of asset performance.

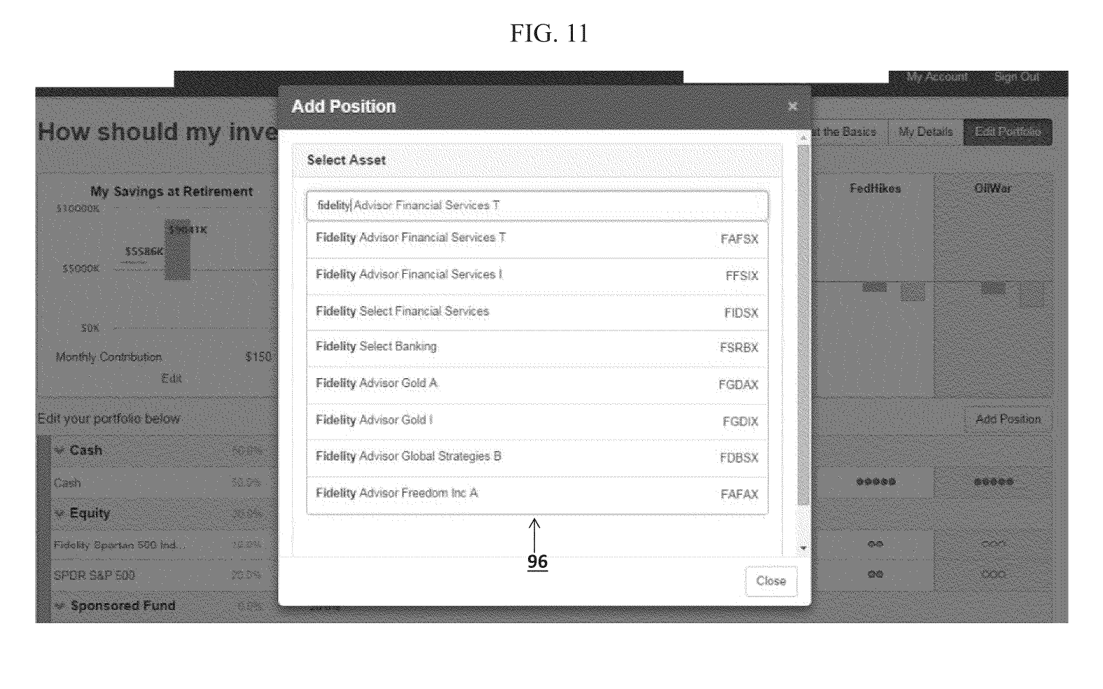

The user interface 12 can be configured to allow for interaction to thereby allow a user to edit his or her portfolio and view the performance changes in real-time. For example, clicking on the button 90 (“edit portfolio”) brings up a window 88, in which a user can change the weight of each of the assets A₁, A₂, A₃, and A₄ within the user's portfolio P₁, can add assets, and/or can remove assets, to thereby create the alternative portfolio P₂. The user can set a desired weight of each of the assets A₁, A₂, A₃, and A₄ by entering a percent of the asset in the overall portfolio in a text box adjacent to the asset. By clicking on a button 92 (“add position”), a window 96 (FIG. 11) can provide the user with a search box to search for assets that the user would like to add to the user portfolio P₁. In some embodiments, clicking on the button 92 can cause the user interface 12 to present the user with a list of pre-selected assets that can be added to the user's portfolio. By clicking on one of the buttons 94 (“improve scenario”), the user can improve performance in the scenario adjacent to the button. In particular, funds selected by the optimization module 30 as performing within a desired performance range in the selected scenario can be added to the user's portfolio P₁.

The alternative portfolio P₂ that reflects any of the aforementioned the user's edits can be automatically input to the performance scenario analysis module 28 to produce updated performance metrics for the alternative portfolio P₂, which are then displayed alongside the performance metrics for the user's current portfolio P₁ to help the user understand the impact of the edits. The user interface 12 can thus allow users to customize their portfolio for performance under certain scenarios while understanding the negative impact to other scenarios. It can also provide accurate, meaningful metrics as compared with traditional risk metrics, and can alert users to the consequences of future adverse events.

It will be appreciated that the systems and methods described herein can be used to promote sponsored assets by demonstrating the effect of the sponsored assets on a user's portfolio. By way of non-limiting example, advertising features can be incorporated into the optimization module 30 by limiting the assets available for screening to sponsored funds. A sponsored fund can be any fund that a sponsor, e.g., a financial institution, wants to promote. The optimization module 30 can thus provide suggestions for sponsored funds based on the aforementioned indicia of a user's preference, which can be varied to ensure a predetermined dispersion of suggestions of sponsored funds.

The one or more suggested sponsored funds can be included in a user's current portfolio and input to the portfolio scenario analysis module 28. The resulting performance metrics of an alternative portfolio that includes the one or more suggested sponsored funds can be displayed on the user interface 12, alongside performance metrics of the user's current portfolio, thereby demonstrating to the user how the one or more suggested sponsored funds would impact the user's current portfolio. On the user interface 12, there can be a user actuable link to information regarding the one or more suggested sponsored funds, each of which can be associated with an advertising fee. For example, the number of clicks on the actuable link can be tracked to cause the optimization module to charge the sponsor a fee for each click. It will be appreciated by a person of skill in the art that promotion of sponsored funds by the systems and methods described herein can be monetized in a variety of ways.

Suggestions for sponsored funds can be provided automatically on the user interface 12, or at the request of the user. For example, the user can be provided with an option to screen for funds from among the sponsored funds, based on one or more scenarios that the user wishes to improve. In the exemplary embodiment of FIG. 9, for example, the user interface 12 can be configured to display a sponsored fund 98 that has been selected by the optimization module 30 as meeting one or more of the user's preferences. The user can request to view the impact of the sponsored fund 98 on the user's portfolio P₂ either by clicking any of the buttons 97 (“improve scenario) and/or by clicking on a button 99 (“graph it!”). In this way, the optimization module 30 can provide users with an environment for immediately understanding the impact of a sponsored fund on the user's current portfolio P₂ and for determining whether the sponsored fund is relevant. The optimization module 30 can also provide advertisers with a highly targeted consumer group that is likely to be interested in their assets.

It will further be appreciated that the systems and methods described herein can be used for retirement planning by applying and of the systems and methods described herein to a limited subset of assets in which a user is permitted to invest for retirement, e.g., to the limited subset of assets that a user can invest in his or her 401K. By way of non-limiting example, a portfolio rate of return that is displayed on the user interface 12 can be a rate of return over a time period extending from the present to an expected date of retirement. Additionally or alternatively, assets suggested for inclusion by the optimization module 30 can be limited to the limited subset of assets in which a user is permitted to invest for retirement.

What is claimed is:

1. A method for forecasting the performance of one or more portfolios of financial assets under one or more economic scenarios using a system consisting of one or more computer processors connected to one or more computer databases, comprising:
accessing by the one or more computer processors data in the one or more databases, the data comprising historical pricing data for a plurality of financial assets and historical valuation data for a plurality of factors with which the historical pricing data can be correlated;
performing by the one or more computer processors a regression analysis for the financial assets with respect to the factors to calculate regression parameters representing correlations between the financial assets and the factors and storing the regression parameters in the one or more databases;
receiving by the one or more computer processors definitions of a plurality of economic scenarios that include predicted values of the factors for the economic scenarios and storing the economic scenarios and the predicted values of the factors in the one or more databases;
receiving by the one or more computer processors a selection of financial assets to form a portfolio; and
accessing the one or more databases by the one or more computer processors to retrieve the regression parameters for each financial asset in the portfolio and one or more economic scenarios including predicted values of the factors for the one or more scenarios and calculating performance metrics of the portfolio under the one or more economic scenarios using the regression parameters and the predicted values of the factors.

2. The method of claim 1, further comprising:
receiving by the one or more computer processors one or more alternative selections of financial assets to form one or more alternative portfolios;
accessing the one or more databases by the one or more computer processors to retrieve the regression parameters for each financial asset in the one or more alternative portfolios and one or more economic scenarios including the predicted values of the factors for the one or more scenarios and calculating performance metrics of the one or more alternative portfolios under the one or more economic scenarios using the regression parameters and the predicted values of the factors; and
outputting by the one or more computer processors the performance metrics of the portfolio and the one or more alternative portfolios under the one or more economic scenarios for display to a user.

3. The method of claim 2, wherein the receiving by the one or more computer processors of the one or more alternative selections of financial assets further comprises:
providing by the one or more computer processors a user interface for a user to indicate allocations of a limited subset of financial assets in which the user is allowed to invest, and creating from indicated allocations the one or more alternative portfolios.

4. The method of claim 2, wherein the receiving by the one or more computer processors of the one or more alternative selections of financial assets further comprises:
providing by the one or more computer processors a user interface for a user to indicate allocations of the assets within the portfolio, and creating from indicated allocations the one or more alternative portfolios.

5. The method of claim 2, wherein the receiving by the one or more computer processors of the one or more alternative selections of financial assets further comprises:
receiving by the one or more computer processors an indication of user preferences relating to portfolio performance under one or more of the scenarios,
selecting by the one or more computer processors of one or more assets for inclusion in the one or more alternative portfolios based on the user preferences.

6. The method of claim 2, further comprising:
calculating by the one or more computer processors of a ranking for a performance of each financial asset under the one or more economic scenarios and storing the rankings in the one or more databases.

7. The method of claim 1, further comprising:
modifying the portfolio by the one or more computer processors by adding one or more sponsored financial assets to create an alternative portfolio;
accessing the one or more databases by the one or more computer processors to retrieve the regression parameters for each financial asset in the alternative portfolio and one or more economic scenarios including the predicted values of the factors for the one or more economic scenarios and calculating performance metrics of the alternative portfolio under the one or more economic scenarios using the regression parameters and the predicted values of the factors; and
outputting by the one or more computer processors the performance metrics of the portfolio and the alternative portfolio under the one or more economic scenarios for display to a user.

8. The method of claim 7, further comprising:
providing by the one or more computer processors a user actuable link to information regarding the one or more sponsored financial assets; and
calculating by the one or more computer processors an advertising fee for the one or more sponsored financial assets.

9. The method of claim 7, wherein modifying the portfolio further comprises:
calculating by the one or more computer processors which one or more from a plurality of sponsored financial assets will optimize the performance of the portfolio under the one or more economic scenarios and adding the one or more sponsored financial assets to the portfolio to create one or more alternative portfolios.

10. The method of claim 1, wherein the plurality of financial assets comprise a limited subset of funds in which a user is allowed to invest.

11. The method of claim 1, further comprising:
clustering by the one or more computer processors the plurality of financial assets into clusters based on the historical pricing data for the plurality of financial assets; and
performing by the one or more computer processors a second regression analysis for the financial assets in each cluster with respect to the factors to determine subsets of the factors for each cluster that are correlated with the financial assets in the cluster.

12. The method of claim 11, wherein performing the regression analysis for the financial assets with respect to the factors comprises performing the regression analysis for the financial assets in each cluster with respect to the subset of factors that are correlated with the cluster.

13. The method of claim 11, further comprising:
determining by the one or more computer processors a goodness of fit of the regression parameters for each of the plurality of financial assets, and where the fit is determined to be below a threshold value, replacing the regression parameters for the financial asset with regression parameters for the cluster.

14. The method of claim 11, further comprising:
comparing by the one or more computer processors the performance metrics for each of the plurality of financial assets with the performance metrics for other financial assets in the same cluster and, where the performance metrics for a financial asset differ from the performance metrics for other financial assets in the same cluster by a predetermined amount, replacing the performance metrics for the financial asset with average values for performance metrics of the cluster.

15. The method of claim 1, wherein the calculating performance metrics of the portfolio under the one or more economic scenarios using the regression parameters and the predicted values of the factors comprises:
calculating performance metrics of each of the plurality of financial assets by the one or more computer processors;
storing the pre-calculated asset performance metrics in the one or more databases; and
calculating performance metrics of the portfolio based on the pre-calculated asset performance metrics.
